(19) United States
(12) Patent Application Publication
(10) Pub. No.: US 2026/0238015 A1
(43) Pub. Date: Aug. 13, 2026

(54) ENERGY MANAGEMENT SYSTEM FOR AN INDUSTRIAL PLANT

(71) Applicant: ABB Schweiz AG, Baden (CH)

(72) Inventors: Prema Juhlin, Heidelberg (DE); Maryam Sharifi, Solna (SE); Jan-Christoph Schlake, Darmstadt (DE); Stefan Thorburn, Västerås (SE); Chen Song, Mannheim (DE); Moksadur Rahman, Västerås (SE); Theresa Loss, Mannheim (DE); Theodor Schoenfisch, Heidelberg (DE)

(21) Appl. No.: 19/153,552

(22) PCT Filed: Feb. 13, 2023
(86) PCT No.: PCT/EP2023/053514

§ 371 Date: Aug. 4, 2025

(51) Int. Cl. H02J 3/38; H02J 103/30; H02J 105/16

(52) U.S. Cl. CPC H02J 3/38; H02J 2103/30; H02J 2105/16

(57) ABSTRACT

An energy management system for an industrial plant comprises an energy consumption model comprises a plurality of asset energy modules. The asset energy modules comprise at least two interchangeable asset energy modules corresponding to at least two respective interchangeable assets of a first asset type. The energy consumption module further comprises a production system energy model for determining a plurality of energy consumptions in a scenario using the first asset type. The production system energy model is configured for determining energy consumptions by interchanging the at least two interchangeable asset energy modules in the production system energy model. The energy management system further comprises a energy production model for determining an energy production by one or more energy sources of the industrial plant. The energy management system further comprises an energy optimizer for configuring the industrial plant based on the plurality of energy consumptions and the energy production.

### CROSS REFERENCE TO RELATED APPLICATIONS

The present application is a national phase entry of International Patent Application No. PCT/EP2023/053514, filed on Feb. 13, 2023, and titled “ENERGY MANAGEMENT SYSTEM FOR AN INDUSTRIAL PLANT,” which is hereby incorporated by reference in its entirety.

### TECHNICAL FIELD

Embodiments of the present disclosure relate to an energy management system for an industrial plant and to an energy management method for an industrial plant. More particularly, systems and methods according to embodiments of the present disclosure may relate to energy management in large industries such as mining, pulp and paper, or metals industry.

### BACKGROUND

Industrial processes are major contributors to greenhouse gas (GHG) emissions and are expected to significantly reduce their carbon footprint. For example, the mining sector is expected to reduce CO₂ emissions by at least 50 percent from 2010 levels by 2050 in line with the global 2° C. target, and by at least 85 percent to limit warming to 1.5° C. (see: McKinsey & Company, “Climate risk and decarbonization: What every mining CEO needs to know,” Metals & Mining and Sustainability Practices, 2020). Reduction efforts may involve both the assessment of GHG reduction initiatives as well as improvement in energy efficiency of existing assets of an industrial plant. Consequently, energy efficiency is increasingly considered a crucial aspect across different industrial sectors, especially in high energy consumption sectors such as mining and minerals (4-7% global energy use, see: K. Rabago, A. Lovins and T. Feiler, “Energy and Sustainable Development in the Mining and Minerals Industries,” Mining, Minerals and Sustainable Development (MMSD), 2001) and pulp and paper (6% global industrial energy use, see: The Institute for Industrial Productivity, “Pulp and Paper,” 30 Apr. 2012 [Online], [retrieved on 14 Sep. 2022], <http://www.iipinetwork.org/wp-content/Ietd/content/pulp-and-paper.html>).

Some basic asset energy consumption-related data is often available from asset manufacturers, such as a mining truck engine tier rating. Present efforts to reduce energy consumption are mainly focused on process and asset optimization, such as asset monitoring for abnormalities, innovative physical processing improvements, or operational efficiency improvements of currently used assets.

However, selecting and configuring appropriate assets suitable for energy-efficient operations in the overall production system often involves comprehensive analyses, for instance with respect to interdependencies with other assets or scheduling impact on downstream operations. Meeting energy efficiency targets or customer targets may involve an extensive trial-and-error procedure, which may result in high cost and inefficiencies in production and energy usage. Thus, there is a need for improved energy management in industrial plants. In particular, there is an increasing need for energy-efficient operations and compliance with standardized energy review processes related to identification and management of assets using significant amounts of energy.

### BRIEF DESCRIPTION

In view of the foregoing, the present disclosure is directed to an energy management system and an energy management method for an industrial plant that can provide improved energy management. In particular, the present disclosure is directed to an energy management using a modular architecture for selecting or managing assets of an industrial plant.

According to an aspect of the present disclosure, an energy management system for an industrial plant is provided. The industrial plant is configured for consuming energy using one or more of a plurality of assets deployable in the industrial plant. The energy management system includes an energy consumption model. The energy consumption model includes a plurality of asset energy modules, each asset energy module including an asset model for a respective asset of the plurality of assets, wherein the plurality of asset energy modules includes at least two interchangeable asset energy modules corresponding to at least two respective interchangeable assets of a first asset type. The energy consumption model further includes a production system energy model for determining a plurality of energy consumptions in a first production scenario using the first asset type, wherein the production system energy model is configured for determining the plurality of energy consumptions by interchanging the at least two interchangeable asset energy modules in the production system energy model. The energy management system further includes an energy production model for determining an energy production by one or more energy sources of the industrial plant, the energy production model including a grid model of a grid of the industrial plant, the grid model including one or more energy source models for the one or more energy sources. The energy management system further includes an energy optimizer for configuring the industrial plant based on the plurality of energy consumptions and the energy production. It should be understood that the energy management system may further include any of the additional features described herein.

According to another aspect of the present disclosure, an energy management method for an industrial plant is provided. The industrial plant is configured for consuming energy using one or more of a plurality of assets deployable in the industrial plant. The energy management method includes modeling, using an energy consumption model, a production scenario of the industrial plant, the production scenario using a first asset type, the first asset type encompassing at least two interchangeable assets of the plurality of assets. The energy consumption model includes a plurality of asset energy modules, each asset energy module including an asset model for a respective asset of the plurality of assets. The plurality of asset energy modules includes at least two interchangeable asset energy modules corresponding to the at least two interchangeable assets of the first asset type. The energy management method includes determining, using a production system energy model of the energy consumption model, a plurality of energy consumptions for the production scenario, wherein determining the plurality of energy consumptions includes interchanging the at least two interchangeable asset energy modules in the production system energy model. The energy management method includes determining, using an energy production model, an energy production by one or more energy sources of the industrial plant, the energy production model including a grid model of a grid of the industrial plant, the grid model including one or more energy source models for the one or more energy sources. The energy management method includes configuring the industrial plant based on the plurality of energy consumptions and the energy production. It should be understood that the energy management method may further include any of the additional operations and/or features described herein.

Systems and methods according to the present disclosure particularly provide an energy management framework, which can provide energy optimization based on input from an energy consumption model of a production side of the industrial plant and based on input from an energy production model. Results from the energy management system can be used for configuring the industrial plant, such as for selecting an asset for the industrial plant from a plurality of interchangeable assets, scheduling of assets of the industrial plant or configuring settings of assets of the industrial plant. Different interchangeable candidate assets corresponding to significant energy uses (SEUs) may be for example assessed based on energy review recommendations such as according to the ISO 50001 standard. Energy source-related grid aspects in the energy production model according to embodiments may support assessment of greenhouse gas reduction, for example according to the ISO 14064 standard. Embodiments according to the present disclosure may particularly support an energy performance assessment of the industrial plant based on a modular model architecture for energy management during various operational phases of the industrial plant, including design, ordering, planning, scheduling and/or asset management.

Embodiments of the present disclosure particularly provide energy management for industrial plants, particularly for large industrial plants and/or industrial plants with high energy consumption. In some embodiments, the industrial plant is a mining plant, a pulp or paper industrial plant, or an industrial metal processing plant. In further embodiments, the industrial plant may be an industrial plant in chemical industry, or food and beverage industry.

According to embodiments of the present disclosure, the industrial plant is configured for consuming energy using a plurality of assets deployable in the industrial plant. The plurality of assets may include one or more equipment assets such as devices or machines deployable in production processes of the industrial plant. The plurality of assets may include one or more system assets. For example, a system asset may be a particular combination, arrangement and/or configuration of multiple equipment assets to operate as a system. The plurality of assets may include one or more facility assets. For instance, a facility asset may be a facility for performing a production process of the industrial plant. The plurality of assets may include one or more process assets. For example, a process asset may include a process program, processing instructions and/or a recipe for a process in the industrial plant, particularly a production process of the industrial plant. As used herein, the term “asset”, for example a “first asset”, particularly refers to a specific piece of equipment such as a specific machine or device, to a specific system, to a specific facility or to a specific process.

In embodiments, the industrial plant is configured to produce energy using one or more energy sources deployable in the industrial plant. The one or more energy sources can include for example one or more renewable energy sources such as solar and/or wind energy sources, one or more fuel energy sources such as a diesel generator, and/or one or more grid energy sources for receiving energy from an external utility grid. According to embodiments, the industrial plant includes a grid. The grid may connect the one or more energy sources of the industrial plant and one or more of the plurality of assets of the industrial plant. In embodiments, the grid may include an electrical grid and/or a thermal energy grid.

According to embodiments, the energy management system includes an energy consumption model. The energy consumption model can be configured to model one or more production scenarios of the industrial plant. For example, the energy consumption model may be configured to provide information on total energy consumption per production scenario. In particular, the energy consumption model may model the one or more production scenarios using a plurality of asset energy modules of the energy consumption model.

In embodiments, each asset energy module of the plurality of asset energy modules includes an asset model for a respective asset of the plurality of assets of the industrial plant. The plurality of asset energy modules may include asset models for assets including one or more equipment assets, one or more system assets, one or more facility assets, and/or one or more process assets. In particular, each asset energy module of the plurality of assets may include one asset model for an equipment asset, for a system asset, for a facility asset, or for a process asset.

In some embodiments, each of the asset energy modules, particularly for equipment assets, includes one or more energy variables for the respective asset, metadata for the respective asset model and/or a physical interface description for the respective asset. A physical interface description may be provided for example by the vendor of the corresponding asset. Each of the asset energy modules for equipment assets, particularly for equipment assets configurable for process automation, may include a control parameter for the respective equipment asset, a communication interface for the respective equipment asset and/or a human machine interface parameter for the respective equipment asset. In particular, the control parameter, the communication interface and/or the human machine interface parameter may be provided as part of a Module Type Package of the respective asset energy module for an equipment asset. A Module Type Package may provide information for integration or interfacing of the energy management system with a distributed control systems (DCS), such as with a system such as 800xA of ABB for process automation. In embodiments, one or more asset energy modules of the plurality of asset energy modules may be based on a description format, for example using AutomationML (Automation Markup Language; IEC 62714) or Asset Administration Shell.

According to embodiments, each of the plurality of asset energy modules includes an interoperable interface for interacting with one or more other asset energy modules of the plurality of asset energy modules. Additionally or alternatively, the interoperable interface may be configured to interact with further components of the energy management system such as with an information integration layer as described herein, and/or with further components of the energy consumption model such as with a production system energy model. For example, an interoperable interface may be provided as a functional mock-up interface (FMI), particularly for an asset energy module including a simulation asset model. In particular, each of one or more asset energy modules may include a functional mockup unit (FMU).

According to embodiments, the plurality of asset energy modules includes at least two interchangeable asset energy modules corresponding to at least two respective interchangeable assets of an asset type. In particular, the plurality of asset energy modules may include a plurality of sets of at least two interchangeable asset energy modules, each set corresponding to an asset type. Different assets pertaining to the same asset type may provide the same function, particularly the same function in a production scenario of the industrial plant. In particular, assets of the same asset type may be interchangeable in a production scenario. For example, in some production scenarios of a mining plant, interchangeable assets of a material transportation asset type may be two or more trucks from different truck vendors, two or more trucks having different technical specifications, or a truck and a conveyor.

In embodiments of the present disclosure, the energy management system includes a production system energy model for determining a plurality of energy consumptions in a production scenario of the industrial plant. A production scenario may be provided as a scenario definition. For instance, a production scenario may include a definition of an operation or of a series of operations in the production of an intermediate product or of an end product of the industrial plant. A production scenario can involve a plurality of asset types, for example one or more process asset types. For example, in a mining plant, a production scenario may include a plurality of process asset types such as the transportation of material and the processing of the material, for example crushing the material. A production scenario can involve further asset types, particularly one or more equipment asset types, one or more system asset types and/or one or more facility asset types of the industrial plant. For instance, a production scenario may define a scenario including the processing of a material in a process asset type by using an equipment asset type in a facility asset type. The specific asset to be used for an asset type, for example a specific machine or device to be used for an equipment asset type, may be determined by an energy optimizer through optimization according to embodiments described herein.

In embodiments, the energy consumption model is configured for determining an energy consumption for each of a plurality of production scenarios of the industrial plant, each production scenario having a respective production system energy model configured for determining the energy consumption for the production scenario based on one or more asset energy modules. The production system energy model may provide one or more energy consumptions per production scenario, particularly one or more total energy consumptions per production scenario. In particular, the production system energy model may provide different energy consumptions for the respective production scenario based on modeling the production scenario using different asset energy modules. The production scenario can be used to select the asset energy modules relevant for the production scenario to interface them with other asset energy modules in the production system energy model. In particular, asset energy modules may be interfaced based on physical interface descriptions contained in the asset energy modules, particularly for equipment assets. Asset models, particularly together with associated metadata, and/or energy variables of asset energy modules may be integrated into the production system energy model. In some embodiments, the production system energy model may provide power consumption requirements per production scenario and/or one or more load models per production scenario to a grid model of an energy production model of the energy management system.

According to embodiments, the plurality of asset energy modules includes at least two interchangeable asset energy modules corresponding to at least two respective interchangeable assets of a first asset type. A production system energy model of the energy consumption model is configured for determining a plurality of energy consumptions in a first production scenario using the first asset type, wherein the production system energy model is configured for determining the plurality of energy consumptions by interchanging the at least two interchangeable asset energy modules in the production system energy model. The plurality of energy consumptions, particularly a plurality of total energy consumptions, may be provided to an energy optimizer according to embodiments described herein.

In some embodiments, the energy management system includes an information integration layer. The information integration layer may support interoperability of different models, inputs and systems of the energy management system. In particular, the information integration layer may be connected to the energy consumption model, the energy production model and/or further components of the energy management system. In embodiments, the information integration layer may be connected to the plurality of asset energy modules. For example, the information integration layer can be configured for harmonizing asset energy data provided by the plurality of asset energy modules for use in the one or more production system energy models. In particular, the information integration layer may provide integration of an asset energy module, particularly of the respective asset model, into a production system energy model. The information integration layer can for example provide integration of asset energy modules or asset models of different origin or of different formats into a production system energy model. The information integration layer may be configured to harmonize energy data provided by the plurality of asset energy modules for instance with respect to measurement units of the asset energy data.

In embodiments, the information integration layer may include plant layout information for the industrial plant, process flow information, one or more production scenarios, result references, optimization constraints for the energy optimizer, and/or grid-related KPIs for the grid of the industrial plant. The information integration layer may provide information integration for example using AutomationML. In some embodiments, for an asset type identified as significant energy use (SEU), which may be identified based on an ISO 50001 energy review, two or more interchangeable asset energy modules may be made available for integration in the production system energy model, particularly via the information integration layer. In some embodiments, the two or more interchangeable asset energy modules may include at least one asset energy module corresponding to a replacement candidate for a currently deployed asset of the industrial plant. For instance, for a currently deployed asset of the industrial plant, the currently deployed asset being a significant energy use, an asset energy module corresponding to the currently deployed asset and a further asset energy module corresponding to one or more replacement candidate assets may be made available for integration in the production system energy model. The production system energy model may determine at least one energy consumption using the asset energy module of the currently deployed asset and at least one further energy consumption using the further asset energy module of the replacement candidate asset.

According to embodiments of the present disclosure, the energy management system includes an energy production model for determining an energy production by one or more energy sources of the industrial plant. The energy production model includes a grid model of the grid of the industrial plant. In particular, the grid model includes one or more energy source models for the one or more energy sources of the industrial plant. In embodiments, the one or more energy source models include at least one energy source model for a renewable energy source, particularly a wind energy source model or a solar energy source model. Additionally or alternatively, the one or more energy source models may include a fuel energy source model, such as a diesel energy source model, and/or a utility grid energy source model. Energy source models may be provided for example as functional mockup units (FMUs).

In embodiments, the grid model may receive inputs such as power consumption requirements per production scenario and/or one or more load models per production scenario from the energy consumption model, particularly from one or more production system energy models. The grid model may receive inputs such as power generation requirements and/or system setpoints from the energy optimizer. For example, the inputs from the energy optimizer may be received by the grid model via a grid planning and scheduling system. The inputs to the grid model may include grid planning and scheduling information. The grid model may determine the energy production by the one or more energy sources, particularly total energy production information. The information on energy production may be provided by the grid model to the energy optimizer.

In embodiments, the energy production model is configured for determining key performance indicators (KPIs) for the grid of the industrial plant based on the grid model, particularly based on output measurements of the grid model. Herein, the key performance indicators for the grid may also be referred to as grid-related KPIs. The grid-related KPIs can be provided as inputs to the energy optimizer. For instance, grid-related KPIs may be provided to the energy optimizer in accordance with ISO 14064-1. Grid-related KPIs may be used for measuring and/or monitoring the energy performance of the production system of the industrial plant. Energy performance may be determined for example using assessments according to ISO 50001 energy review and/or ISO 14064 greenhouse gas reduction initiatives. In embodiments, energy performance may be determined by the energy management system based on one or more of the following aspects. One, the use of renewable energy sources such as solar and/or wind energy sources, particularly to meet climate change goals by reducing energy-related greenhouse gas emissions. Two, assessing the renewable energy production, particularly in terms of their availability and operation costs. Three, reliability: determining scheduling in the usage of renewables for the highest reliability, such as determining the optimal time to utilize energy from wind, solar or other energy sources. Four, meeting energy consumption targets: by continuously assessing the demand side requirements and considering the grid design. Five, the allocation of resources: determining which combination of renewable energy, energy from fuels such as diesel, energy from the utility grid and/or from other sources, provides the most efficient production with lowest cost. Six, fault detection: switching to an islanding mode of the industrial plant whenever a fault in the utility grid is identified. Seven, stability requirements: appropriate control design for the grid such as voltage (frequency) control and/or current (power) control.

According to embodiments of the present disclosure, the energy management system includes an energy optimizer for configuring the industrial plant based on the plurality of energy consumptions and the energy production. Herein, the energy optimizer may also be referred to as an energy optimization module of the energy management system. The energy optimizer may be configured to provide overall energy optimization based on the plurality of energy consumptions provided by the energy consumption model and based on the energy production provided by the energy production model. Optimization by the energy optimizer may further be based on optimization parameters and/or optimization constraints, such as cost information. Optimization parameters and/or optimization constraints may be provided to the energy optimizer for example by the information integration layer. Optimization by the energy optimizer may be based on grid-related KPIs calculated by the energy production model.

For example, energy optimization by the energy optimizer may be performed for overall energy efficiency of the industrial plant based on the energy consumptions provided by the energy consumption model and based on the energy production provided by the energy production model. The optimization may be performed under optimization constraints with respect to greenhouse gas emissions, such as based on an energy performance assessment, and/or with respect to energy costs, such as based on cost information provided by the information integration layer.

In some embodiments, configuring the industrial plant by the energy optimizer includes selecting an asset for an asset type in a production scenario of the industrial plant. For example, the production system energy model may provide to the energy optimizer a plurality of energy consumptions for a first production scenario by interchanging at least two interchangeable asset energy modules of a first asset type. The energy optimizer may be configured to select for the first asset type a first asset corresponding to one of at least two interchangeable asset energy modules based on the plurality of energy consumptions provided by the production system energy model and particularly further based on the energy production provided by the energy production model. In some embodiments, the energy optimizer may be configured for interfacing with a design and ordering system of the industrial plant and/or with an asset management system of the industrial plant. For example, the energy optimizer may output an asset selection to a design and ordering system of the industrial plant.

According to some embodiments, configuring the industrial plant by the energy optimizer includes scheduling the execution of the production scenario, such as of the first production scenario referred to herein, based on the plurality of energy consumptions and the energy production. For instance, the energy optimizer may be configured to interface to a manufacturing execution system (MES) of the industrial plant for scheduling the execution of the production scenario, such as to a manufacturing execution system such as part of ABB Ability Manufacturing Operations Management (MOM).

In embodiments, each of one or more asset energy modules of the plurality of asset energy modules includes an asset configuration parameter. The energy consumption model may be configured for determining the plurality of energy consumptions based on different settings of the asset configuration parameter. The energy optimizer may be configured for determining a first asset configuration setting for the one or more asset energy modules, particularly by optimizing energy usage for one or more production scenarios based on the plurality of energy consumptions and the energy production. Configuring the industrial plant by the energy optimizer may include configuring settings of one or more assets corresponding to the one or more asset energy modules, particularly based on the first asset configuration setting for the one or more assets.

In some embodiments, the energy optimizer may provide power generation requirements and/or system setpoints to the grid model of the energy production model. In embodiments, configuring the industrial plant by the energy optimizer may further include configuring one or more energy sources based on the plurality of energy consumptions and the energy production, for example via a grid planning and scheduling system.

According to embodiments of the present disclosure, an energy management method for an industrial plant is provided. The energy management method may use an energy management system according to embodiments described herein. In particular, the energy management method may include any operations performed by the energy management system as described herein, for example operations performed by the energy consumption model, by the energy production model, by the energy optimizer, by the information integration layer and/or by modules or models of components of the energy management system. The industrial plant may be configured according to embodiments described herein, particularly for consuming energy using one or more of a plurality of assets deployable in the industrial plant. The plurality of assets may be deployable for performing operations in the industrial plant. For example, a plurality of assets deployable in a mining plant may include a variety of different conveyors, for example from different vendors, the conveyors being deployable for transportation of material in the mining plant. It should be understood that the mining plant may include one or more of the variety of different conveyors, but does not have to include every one of the variety of different conveyors. Embodiments of the present disclosure for instance provide an energy management method or energy management system for selecting one or more—from an energy management point of view—best fitting conveyors from the variety of different conveyors using asset energy modules corresponding to the variety of different conveyors deployable in the mining plant. It should be understood that the example referring to conveyors in a mining plant can be applied generally to assets in industrial plants according to embodiments described herein.

In embodiments, the method includes modeling, using an energy consumption model, a production scenario of the industrial plant, particularly a first production scenario. The production scenario uses a first asset type. The first asset type may be one of a plurality of asset types used in the industrial plant as described in the present disclosure. In particular, the first asset type encompasses at least two interchangeable assets of the plurality of assets of the industrial plant. The energy consumption model includes a plurality of asset energy modules according to embodiments described herein. Each asset energy module includes an asset model for a respective asset of the plurality of assets, wherein the plurality of asset energy modules includes at least two interchangeable asset energy modules corresponding to the at least two interchangeable assets of the first asset type.

In embodiments, the energy management method includes determining, using a production system energy model of the energy consumption model, a plurality of energy consumptions for the production scenario, wherein determining the plurality of energy consumptions includes interchanging the at least two interchangeable asset energy modules in the production system energy model. In some embodiments, the method may include harmonizing, by an information integration layer of the energy management system, asset energy data from the at least two interchangeable asset energy modules for use in the production system energy model.

According to embodiments, the method includes determining, using an energy production model, an energy production by one or more energy sources of the industrial plant. The energy production model particularly includes a grid model of a grid of the industrial plant, the grid model including one or more energy source models for the one or more energy sources. The method may include determining, using the energy production model, grid-related KPIs based on output measurements of the grid model.

In embodiments, the method includes configuring, particularly by an energy optimizer of the energy management system, the industrial plant based on the plurality of energy consumptions and the energy production. Configuring the industrial plant by an energy optimizer may further be based on grid-related KPIs calculated by the energy production model, optimization parameters and/or optimization constraints provided by the information integration layer. For example, configuring the industrial plant may include selecting for the first asset type a first asset of the at least two interchangeable assets, the first asset corresponding to one of the at least two interchangeable asset energy modules. Additionally or alternatively, configuring the industrial plant may include scheduling the execution of the production scenario and/or configuring settings of one or more assets of the industrial plant according to embodiments described herein.

According to embodiments, an energy management system for the industrial plant includes a data system, for example for storage of the models of the energy management system, of the asset energy modules, and/or of data and application files of the integration information layer and/or of the energy optimizer. The data system may for example include application files, one or more databases, tables and/or further data structures. The data system may be provided on a memory device. The energy management system can include one or more processors, particularly for executing operations such as calculations, simulations and/or optimizations. The energy management system can include one or more human machine interfaces (HMIs).

In embodiments, a processor may include a central processing unit (CPU). To facilitate performing operations according to embodiments described herein, the processor may be one of any form of general purpose computer processor. The memory device containing the data system and/or a computer-readable medium may be coupled to the processor. The memory device and/or the computer readable medium may be one or more readily available memory devices such as random access memory, read only memory, hard disk, or any other form of digital storage either local or remote, such as cloud-based storage. The processor may be coupled to support circuits for supporting the processor in a conventional manner. These circuits may include cache, power supplies, clock circuits, input/output circuitry and related subsystems, and the like. In some embodiments, the energy management system may be coupled to a control system configured for controlling and/or monitoring the industrial plant, such as to a distributed control system (DCS). The energy management system may be coupled to a manufacturing execution system (MES), to an asset management system and/or to an ordering and design system.

Instructions for operations performed by the energy management system or according to the energy management method described herein may be stored in the computer-readable medium as one or more software routines typically known as a recipe. A software routine, when executed by the processor, transforms the general purpose computer into a specific purpose computer, and can cause the system to carry out a method or any operations of the energy management system according to embodiments of the present disclosure. Although operations and methods of the present disclosure may be implemented as a software routine, some of the operations that are disclosed herein may be performed in hardware as well as by software. As such, the embodiments may be implemented in software as executed upon a computer system, and hardware as an application specific integrated circuit or other type of hardware implementation, or a combination of software and hardware. According to embodiments described herein, the operations of the energy management system can be conducted using computer programs, software, computer software products and/or input and output devices being in communication with components of the industrial plant. In some embodiments, a software conducting methods or operations of embodiments described herein may run concurrently with the operation of the industrial plant, particularly in real time. According to some embodiments, the energy management system may be configured to at least partially plan, schedule and/or control the operation of the industrial plant by interfacing with a control system of the industrial plant.

Embodiments of the present disclosure may advantageously provide a module-based approach for asset selection, asset scheduling, asset configuration and/or asset management based on asset energy modules as described in the present disclosure. Considering an industrial plant as a modular system, methods and systems according to the present disclosure can support an energy-optimization-based evaluation of an exchange of currently used assets of the industrial plant with more suitable assets. For instance, more suitable assets from different vendors may be assessed for use in the industrial plant based on a standardized representation of asset energy information. Further, systems and methods described herein may support reduction of greenhouse gas emissions by the industrial plant. Additionally or alternatively, embodiments can provide relevant feedback to manufacturing execution systems and/or asset performance management systems, for example as part of New Generation Automation.

A standardized representation of asset energy information through an asset energy module, particularly through a vendor-independent asset energy module, may advantageously allow for easier replacement of assets with more energy-efficient alternatives as and when they become available based on evaluation of assets from multiple vendors. In particular, the asset energy modules may provide easier alignment and interfacing between asset vendors and the industrial plant owner towards the determination of best fitting assets for production processes. Significant gains can be expected to be made for example by replacing currently deployed equipment, estimated to contribute around 60% of total energy consumption in mining plants (see: M. Allen, “A high-level study into mining energy use for the key mineral commodities of the future,” [online], <https://www.ceecthefuture.org/resources/mining-energy-consumption-2021#:~:text=From%20the%20breakdown%20of%20energy,%25%20and%20other%20elect ricity%2014%25>), by more energy-efficient ones. Embodiments may allow for efficiency improvements to be considered more broadly for assets covering equipment, facilities, systems, and/or processes, particularly for significant energy use (SEU) assets. Systems and methods of the present disclosure can be configured to support relevant ISO standards mentioned herein towards optimal selection, configuration and management of assets for energy efficiency management. Energy management systems of the present disclosure may be integrated in existing energy management systems such as ABB OPTIMAX, particularly in combination with grid-related KPIs supporting greenhouse gas emission reduction initiatives for supporting continual energy management of production systems.

The use of the asset energy modules may further allow for increased operational flexibility based on matching of asset parameters with process variables from process requirements. Further advantages of the use of the asset energy modules may include an improved system integration based on earlier model integration and execution for different production scenarios with different modules based on interoperable integration of asset model information. Asset energy modules according to embodiments may allow for advanced holistic analyses with energy optimization for improved energy efficiency, particularly while ensuring smooth operation of the industrial plant.

Further aspects, benefits, and features of the present disclosure are apparent from the claims, the description, and the accompanying drawings.

### BRIEF DESCRIPTION OF DRAWINGS

The accompanying drawings relate to embodiments of the disclosure and are described below.

FIG. 1 schematically illustrates an energy management system according to an embodiment of the present disclosure.

FIG. 2 schematically illustrates an asset energy module for an equipment asset.

FIG. 3 schematically illustrates an energy management system according to a further embodiment of the present disclosure.

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

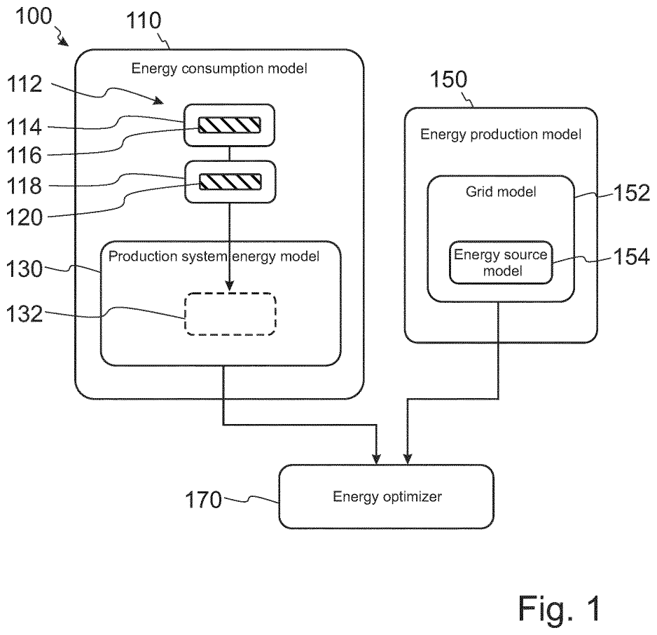

FIG. 1 illustrates an energy management system 100 for an industrial plant. The energy management system 100 includes an energy consumption model 110, an energy production model 150 and an energy optimizer 170. The energy consumption model 110 includes a plurality of asset energy modules 112. The plurality of asset energy modules 112 for example includes a first asset energy module 114 with a first asset model 116 for a first asset, the first asset being deployable in the industrial plant. The plurality of asset energy modules 112 further includes a second asset energy module 118 with a second asset model 120 for a second asset, the second asset being deployable in the industrial plant. In particular, the first asset and the second asset are of a first asset type. More specifically, the first asset and the second asset are interchangeable assets in a first production scenario of the industrial plant. For instance, the first asset may be an asset currently deployed in the industrial plant. The second asset may be a replacement candidate for the first asset.

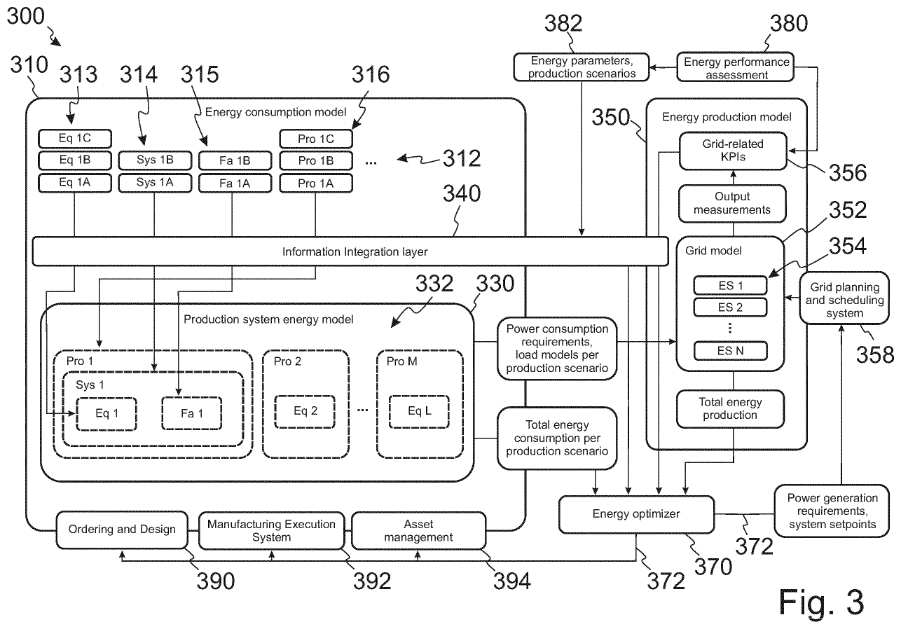

Similar to the first asset and the second asset being interchangeable in the industrial plant, the first asset energy module 114 and the second asset energy module 118 are interchangeable in a production system energy model 130 of the energy consumption model 110, wherein the production system energy model 130 provides a model of the first production scenario. Each of the first asset energy module 114 and the second asset energy module may interface via a module interface 132 with the production system energy model 130, either directly or via an information integration layer (see, for example, FIG. 3). The production system energy model 130 can model the first production scenario using the first asset energy module 114, particularly using the first asset model 116 for the first asset and possibly further information contained in the first asset energy module 114. Using the first asset energy module 114, the production system energy model 130 determines a first energy consumption for the first production scenario. The production system energy model 130 separately models the first production scenario using the second asset energy module 118 instead of the first asset energy module 114 and determines a second energy consumption for the first production scenario. The first energy consumption and the second energy consumption determined by the production system energy model 130 are provided to the energy optimizer 170. Although the above example describes the calculation of only two energy consumptions, it should be understood that in further embodiments, more than two energy consumptions may be determined, for example using more than one asset type in a production scenario, using more than two interchangeable asset energy modules, and/or using different settings or configurations for the asset energy modules.

The energy production model 150 shown in FIG. 1 includes a grid model 152 for a grid of the industrial plant. The grid model 152 includes an energy source model 154 corresponding to an energy source deployable in the industrial plant. The grid model 152 is configured for determining an energy production by the energy source using the energy source model 154. The energy production model 150 provides the determined energy production to the energy optimizer 170. Based on the energy consumptions provided by the energy consumption model, particularly the first energy consumption and the second energy consumption, and further based on the energy production provided by the energy production model, the energy optimizer 170 configures the industrial plant, for example by selecting whether to replace the first asset with the second asset in the first production scenario of the industrial plant.

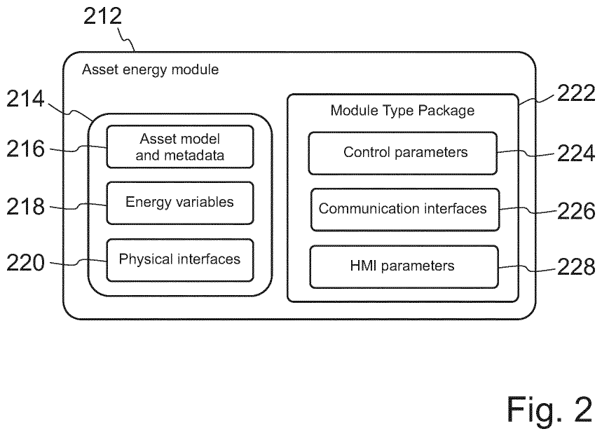

FIG. 2 illustrates an exemplary asset energy module 212 for an asset deployable in an industrial plant, particularly for an equipment asset. The asset energy module 212 includes an energy model component 214 including an asset model 216 for the asset and related metadata. The energy model component 214 further includes energy variables 218 and a physical interface description 220 for the asset. The asset energy module 212 further includes a Module Type Package 222. The Module Type Package 222 includes control parameters 224, communication interfaces 226 and human machine interface (HMI) parameters 228. The Module Type Package can be provided particularly for equipment assets for easier integration with a distributed control system (DCS). Asset energy modules for assets other than equipment assets may be provided without a Module Type Package.

FIG. 3 illustrates a further embodiment of an energy management system 300 according to a further embodiment. The energy management system 300 includes an energy consumption model 310 with a plurality of asset energy modules 312. The plurality of asset energy modules 312 can be used for example to model a first production scenario in a production system energy model 330. The plurality of asset energy modules 312 can be integrated into the production system energy model 330 via an information integration layer 340 of the energy management system 300. The information integration layer 340 can particularly harmonize energy data of the plurality of asset energy modules 312 for use by the production system energy model 330.

The production system energy model 330 is configured for modeling the first production scenario using a plurality of module interfaces 332 to interface with the plurality of asset energy modules 312, particularly via the information integration layer 340. For example, the first production scenario may include a plurality of processes 1, 2, . . . , M. For each of the processes 1, 2, . . . , M, the production system energy model 330 includes a process module interface for a respective process asset type Pro 1 . . . Pro M. For process asset type Pro 1, the energy consumption model includes a plurality of interchangeable process asset energy modules 316, particularly three interchangeable process asset energy modules Pro 1A, Pro 1B, Pro 1C. For example, the different process asset energy modules may contain different process recipes in respective process asset models for the process asset type Pro 1. The production system energy model 330 further includes a system module interface for a system asset type Sys 1, an equipment module interface for an equipment asset type Eq 1, and a facility module interface for a facility asset type Fa 1, the asset types Sys 1, Eq 1 and Fa 1 being related to the process asset types Pro 1. More specifically, the production system energy model 330 of FIG. 3 is configured to model a process of process asset type Pro 1 using a system of system asset type Sys 1, equipment of equipment asset type Eq 1, and a facility of facility asset type Fa 1. The production system energy model 330 includes a plurality of interchangeable equipment asset energy modules 313 for the equipment asset type Eq 1, specifically three interchangeable equipment asset energy modules Eq 1A, Eq 1B, Eq 1C. The equipment asset energy modules may be provided for example as described in connection with FIG. 2. The production system energy model 330 further includes a plurality of interchangeable system asset energy modules 314 for the system asset type Sys 1, specifically two interchangeable system asset energy modules Sys 1A, Sys 1B, and a plurality of interchangeable facility asset energy modules 315 for the facility asset type Fa 1, specifically two interchangeable facility asset energy modules Fa 1A, Fa 1B.

Additionally, the production system energy model 330 includes one or more asset energy modules (not shown) for each of asset types Pro 2, . . . Pro M, Eq 2, . . . Eq L. Further, although process asset types Pro 2 and Pro M are illustrated as only using an equipment asset type, it should be understood that some processes may involve one or more equipment asset types, one or more system asset types and/or one or more facility asset types. Asset energy modules may be provided particularly for significant energy uses (SEUs).

By interchanging different asset energy modules for an asset type in the production system energy model 330 and respectively modeling the first production scenario, the production system energy model 330 determines a plurality of total energy consumptions for the first production scenario as an output to the energy optimizer 370. Further, the production system energy model 330 outputs power consumption requirements and load models for the first production scenario to a grid model 352 of an energy production model 350 of the energy management system 300. The energy management system 300 can additionally include further production system energy models for modeling further production scenarios of the industrial plant.

The energy production model 350 includes the grid model 352 with a plurality of energy source models 354 (ES 1, ES 2, . . ., ES N) for a plurality of energy sources of the industrial plant, particularly including energy source models for renewable energy sources of the industrial plant. The grid model 352 uses the plurality of energy source models 354 and further inputs, for example from the energy consumption model 310 and/or from a grid planning and scheduling system 358 of the energy management system 300, to determine a total energy production that is output to the energy optimizer 370.

The energy production model 350 is further configured to use output measurements of the grid model 352 to determine grid-related KPIs 356. In FIG. 3, the determination of the grid-related KPIs 356 is further based on an energy performance assessment 380 performed by the energy management system 300. For instance, the energy performance assessment 380 can be based on an ISO 50001 energy review and/or an ISO 14064 greenhouse gas reduction initiative. The energy performance assessment 380 further yields energy parameters and production scenarios 382, which are provided to the information integration layer 340 of the energy management system 300. Energy parameters include for example energy baselines (EnBs), energy performance indicators (EnPIs) or identified significant energy uses (SEUs) in the production scenarios.

The information integration layer 340 provides interoperability between various components of the energy management system 300 such as between the energy consumption model 310, models and modules of the energy consumption model 310, the energy production model 350, the energy performance assessment 380 and/or the energy optimizer 370. In FIG. 3, the information integration layer 340 for example includes process flows, production scenarios, and optimization parameters including optimization constraints and result references.

The energy optimizer 370 uses the plurality of total energy consumptions provided by the energy consumption model 310, the total energy production and the grid-related KPIs provided by the energy production model 350, and optimization parameters and constraints provided by the information integration layer 340 for energy optimization of the industrial plant. Based on the energy optimization, the energy optimizer 370 provides plant configuration information 372, for example power generation requirements and system setpoints to the grid planning and scheduling system 358. Further, based on the energy optimization, the energy optimizer 370 configures the industrial plant by interfacing with various systems of the industrial plant. In particular, the energy optimizer 370 is configured to select an asset corresponding to one of the plurality of asset energy modules 312 for deployment in the industrial plant. The energy optimizer 370 can interface with an ordering and design system 390 for example to provide asset selections to the ordering and design system 390. The energy optimizer 370 can be configured to determine optimal configurations or settings for assets of the industrial plant according to embodiments described herein. The energy optimizer 370 can for example interface with a manufacturing execution system 392 of the industrial plant and provide asset configurations and/or scheduling information to the manufacturing execution system 392. Further, the energy optimizer 370 can interface with an asset management system 394 of the industrial plant and provide asset management-relevant information such as maintenance information to the asset management system 394. The energy management systems and methods described herein can support in a systematic manner the selection and integration of suitable assets with appropriate configuration into an industrial plant, particularly to achieve a high energy efficiency in the industrial plant and to meet relevant customer targets, avoiding extensive trial-and-error procedures, high costs and/or inefficiencies in production by the industrial plant.

While the foregoing is directed to embodiments of the disclosure, other and further embodiments of the disclosure may be devised without departing from the basic scope thereof, and the scope thereof is determined by the claims that follow.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An energy management system for an industrial plant, the industrial plant configured to consume energy using one or more of a plurality of assets deployable in the industrial plant, the energy management system comprising:
an energy consumption model comprising:
a plurality of asset energy modules, each asset energy module comprising an asset model for a respective asset of the plurality of assets, wherein the plurality of asset energy modules comprises at least two interchangeable asset energy modules corresponding to at least two respective interchangeable assets of a first asset type; and
a production system energy model configured to determine a plurality of energy consumptions in a first production scenario using the first asset type, wherein the production system energy model is configured to determine the plurality of energy consumptions by interchanging the at least two interchangeable asset energy modules in the production system energy model; and
an energy production model configured to determine an energy production by one or more energy sources of the industrial plant, the energy production model comprising a grid model of a grid of the industrial plant, the grid model including one or more energy source models for the one or more energy sources; and
an energy optimizer that configures the industrial plant based on the plurality of energy consumptions and the energy production.

2. The energy management system of claim 1, wherein the plurality of asset energy modules comprises asset models for assets comprising at least one of:
one or more equipment assets;
one or more system assets;
one or more facility assets; and
one or more process assets.

3. The energy management system of claim 2, wherein each of the asset energy modules for the one or more equipment assets further comprises:
one or more energy variables for the respective equipment asset;
metadata for the respective asset model;
a physical interface description for the respective equipment asset;
a control parameter for the respective equipment asset;
a communication interface for the respective equipment asset; and/or
a human machine interface parameter for the respective equipment asset.

4. The energy management system of claim 1, wherein each of the plurality of asset energy modules comprises an interoperable interface configured to interface with:
one or more other asset energy modules,
an information integration layer of the energy management system, and/or
the production system energy model.

5. The energy management system of claim 1, further comprising an information integration layer connected to the plurality of asset energy modules the information integration layer configured to harmonize asset energy data provided by the plurality of asset energy modules for use in the production system energy model.

6. The energy management system of claim 5, wherein the information integration layer further comprises:
plant layout information for the industrial plant;
one or more production scenarios for the industrial plant; and/or
key performance indicators for the grid of the industrial plant.

7. The energy management system of claim 1, wherein the energy production model is configured to determine key performance indicators for the grid of the industrial plant based on the grid model.

8. The energy management system claim 1, wherein the one or more energy source models include at least one energy source model for a renewable energy source.

9. The energy management system of claim 1, wherein the energy consumption model is configured to determine an energy consumption for each of a plurality of production scenarios of the industrial plant, each production scenario having a respective production system energy model configured to determine the energy consumption for the production scenario based on one or more asset energy modules.

10. The energy management system of claim 1, wherein the configuration of the industrial plant by the energy optimizer comprises selecting, for the first asset type, a first asset corresponding to one of the at least two interchangeable asset energy modules.

11. The energy management system of claim 1, wherein the configuration of the industrial plant by the energy optimizer comprises scheduling execution of the first production scenario based on the plurality of energy consumptions and the energy production.

12. The energy management system of claim 1, wherein:
each of one or more asset energy modules of the plurality of asset energy modules comprises an asset configuration parameter,
the energy consumption model is configured to determine the plurality of energy consumptions based on different settings of the asset configuration parameter, and
the configuration of the industrial plant by the energy optimizer comprises configuring settings of one or more assets corresponding to the one or more asset energy modules based on the plurality of energy consumptions and the energy production.

13. The energy management system of claim 1, wherein the industrial plant is a mining plant, a pulp or paper industrial plant, or an industrial metal processing plant.

14. An energy management method for an industrial plant, the industrial plant configured to consume energy using one or more of a plurality of assets deployable in the industrial plant, the energy management method comprising:
modeling, using an energy consumption model, a production scenario of the industrial plant, the production scenario using a first asset type, the first asset type encompassing at least two interchangeable assets of the plurality of assets, wherein:
the energy consumption model comprises a plurality of asset energy modules, each asset energy module comprising an asset model for a respective asset of the plurality of assets, and
the plurality of asset energy modules comprises at least two interchangeable asset energy modules corresponding to the at least two interchangeable assets of the first asset type;
determining, using a production system energy model of the energy consumption model a plurality of energy consumptions for the production scenario, wherein determining the plurality of energy consumptions comprises interchanging the at least two interchangeable asset energy modules in the production system energy model;
determining, using an energy production model, an energy production by one or more energy sources of the industrial plant, the energy production model comprising a grid model of a grid of the industrial plant, the grid model including one or more energy source models for the one or more energy sources; and
configuring the industrial plant based on the plurality of energy consumptions and the energy production.

15. The energy management method of claim 14, wherein configuring the industrial plant comprises selecting, for the first asset type, a first asset of the at least two interchangeable assets, the first asset corresponding to one of the at least two interchangeable asset energy modules.

16. The energy management method of claim 14, wherein configuring the industrial plant comprises scheduling execution of the production scenario based on the plurality of energy consumptions and the energy production.

17. The energy management method of claim 14, wherein:
each of one or more asset energy modules of the plurality of asset energy modules comprises an asset configuration parameter,
the energy consumption model is configured to determine the plurality of energy consumptions based on different settings of the asset configuration parameter, and
configuring the industrial plant comprises configuring settings of one or more assets corresponding to the one or more asset energy modules based on the plurality of energy consumptions and the energy production.

18. The energy management method of claim 14, wherein the industrial plant is a mining plant, a pulp or paper industrial plant, or an industrial metal processing plant.

19. The energy management method of claim 14, wherein the plurality of asset energy modules comprises asset models for assets from the group comprising:
one or more equipment assets;
one or more system assets;
one or more facility assets; and
one or more process assets.

20. The energy management method of claim 19, wherein each of the asset energy modules for the one or more equipment assets further comprises:
one or more energy variables for the respective equipment asset;
metadata for the respective asset model;
a physical interface description for the respective equipment asset;
a control parameter for the respective equipment asset;
a communication interface for the respective equipment asset; and/or
a human machine interface parameter for the respective equipment asset.
